(19) United States
(12) Patent Application Publication
(10) Pub. No.: US 2012/0125904 A1
(43) Pub. Date: May 24, 2012

(54) WELDING NOZZLE

(75) Inventors: Chris Lee, Gladstone, OR (US); Charlie Smith, Tualatin, OR (US)

(73) Assignee: LV Dynamics, LLC

(21) Appl. No.: 13/101,070

(22) Filed: May 4, 2011

Related U.S. Application Data
(60) Provisional application No. 61/415,935, filed on Nov. 22, 2010.

(51) Int. Cl. B23K 9/26

(52) U.S. Cl. 219/137.61

(57) ABSTRACT

An exemplary welding nozzle has a smooth, highly polished bore of circular cross-section. The bore has a forward portion of generally flared, gradually curving shape, joined with a narrowing inner portion along a gradual curve. Hence a concentrated surface flow of shielding gas may be directed out the nozzle's mouth to reliably provide a flared shielding envelope having reinforced boundaries. The inner portion tapers inwardly at a constant angle for a length sufficient to dampen flow disturbances. Hence an inner core of shielding gas of high ionization potential may be directed in laminar flow out the nozzle's mouth for concentration immediately about the exposed electrode to stabilize the electric arc at the electrode tip. The diverging gas flows enable significantly reduced gas consumption while reliably maintaining weld quality, a reduced rate of spatter buildup within the nozzle, and increased versatility of welding tip operation in both automated and manual environments.

### CROSS REFERENCE TO RELATED APPLICATION

This application claims the benefit of U.S. Provisional Patent Application No. 61/415,935, filed Nov. 22, 2010, which is incorporated herein by reference.

### FIELD

The present invention relates to welding tips used on welding guns. In particular, the present invention relates to welding nozzles used on welding tips for use in arc welding.

### BACKGROUND

In MIG (metal inert gas) welding, a form of arc welding, a continuous length of consumable welding wire is fed into and out of the tip of the welding gun. During the welding operation, the wire tip is positioned just over, and is charged at a large potential difference relative to, the workpiece so as to cause an electric arc to form in the gap between the tip and workpiece. The high energy of the arc melts the wire tip (electrode) so that metal droplets from the tip are deposited on the workpiece to form the metal weld.

In this process, the nozzle of the gun blows out a curtain of inert (or semi-inert) shielding gas, such as argon (or carbon dioxide). The nozzle is used to evenly direct the shielding gas into the welding zone. If the flow is inconsistent, it may not provide adequate protection of the weld area. In particular, if atmospheric elements, such as oxygen, penetrate the gas envelope, this may cause defects in the weld, such as porosity (numerous small bubbles) within the weld metal. A MIG welding nozzle of representative design, of a type manufactured by Tweco Products, Inc. based in Wichita, Kan., is shown in FIG. 7 of Stuart et al. U.S. Pat. No. 5,440,100.

Welding flat surfaces requires a higher gas flow than welding grooved surfaces since, without any cavity to contain it, the gas is dispersed more quickly. Likewise increased gas flow is required where movement in the surrounding air may occur, such as in outdoor environments. Inadequate gas flow may cause the quality of the weld to become overly sensitive to changes in the position of the wire tip relative to the workpiece so that much greater skill is required by the operator if the welding tool is being manually manipulated. Typically, using a spray arc process, the rate of gas flow used in indoor welding is 45-50 CFH (cubic feet per hour) while for short arc welding, the flow rate is 30-35 CFH. Replenishing the supply of inert gas is one of the largest costs associated with MIG welding.

During the welding operation, arc blow away and splash back of the metal particles form “gumbo” or “spatter” in the nozzle. Buildup of spatter reduces consistency of the gas flow and the quality of the weld. Typically the spatter is scraped off using the blade of a scraping tool or reamer, but this slows down the wielding process and soon damages the nozzle so that the nozzle must be frequently replaced. Damaged nozzles may also suck in outside air so as to further contribute to weld defects.

Bernard U.S. Pat. No. 2,833,913 describes an alternative to removing the spatter, comprising a spring-biased ramrod with a ram head slideably positioned in the nozzle for driving the spatter out. This, however, requires custom design, defeats interchangeability with standard parts, and relies on a complex manufacturing process.

In addition to protecting the weld, the shielding gas performs a number of other functions including concentrating the arc energy, stabilizing the arc roots on the weld, and ensuring smooth transfer of molten droplets from the wire to the weld pool. Church U.S. Pat. No. 4,572,942, McGee et al. U.S. Pat. No. 5,302,804, and Murakami et al. U.S. Pat. No. 5,347,098 describe how the gas flow may be directed to concentrate the energy of the arc. Igl et al. U.S. Pat. No. 5,973,292 describes a nozzle having a flared end providing convenient access for scraping off the spatter. However, Igl's particular design addresses spatter only after the fact, fails to limit the rate of spatter buildup, and is of questionable effectiveness in maintaining proper droplet transfer and arc stability.

Accordingly, an object of at least certain embodiments is to provide a welding nozzle offering several advantages over existing designs.

An object of at least certain embodiments is to provide a welding nozzle for which the quality of the weld is less subject to precise tip positioning, gas dispersion, or spatter buildup.

Another object of at least certain embodiments is to provide a welding nozzle that conserves on gas usage and requires less frequent nozzle replacement.

Still another object of at least certain embodiments is to provide a welding nozzle that is simple to use, convenient to manufacture, and is usable interchangeably with standard parts.

### SUMMARY

In one aspect in accordance with at least one embodiment, a welding tip is provided comprising a hollow nozzle having an inner wall forming a bore, the bore including a forward portion terminating in an open mouth and an inner portion joined to the forward portion. The forward portion has a generally flared shape and the inner wall is substantially smooth where the inner portion joins the forward portion. The inner portion is configured to restrict any expansion of gas traveling along the inner portion adjacent to the forward portion. The flared shape of the forward portion creates an expanded shielding envelope around the weld while, simultaneously, the inner wall smoothness helps reduce gas flow disturbances. The restriction on gas expansion at least maintains the gas pressure adjacent the forward portion for improved flow adherence to the forward portion so that a greater proportion of the gas flows into the boundary of the shielding envelope.

In a second aspect, a welding tip is provided comprising a hollow nozzle having an inner wall forming a bore, the bore including a forward portion and an inner portion adjoining the forward portion. The forward portion opens outwardly to terminate in an open mouth. The inner portion tapers inwardly in approaching the forward portion. In this manner, surface gas flowing along the forward portion may be discharged along the boundaries of the shielding envelope while an inner core of gas flowing in accordance with the inward taper of the inner portion may concentrate about the electrode wire, with these diverging flows helping to ensure weld quality with minimal gas consumption and spatter buildup.

In a third aspect, a welding tip is provided comprising a hollow nozzle having an inner wall forming a bore, the bore including a forward portion and an inner portion adjoining the forward portion. The forward portion opens outwardly and terminates in an open mouth. The inner wall gradually curves to join the inner portion and the forward portion together. The outwardly opening configuration of the forward portion creates an expanded shielding envelope around the weld. Simultaneously, the gradual curve of the inner wall joining the inner portion and the forward portion together allows the gas flow to easily bridge the transition between the inner and forward portions while continuing to closely follow the forward portion so that a greater proportion of the gas flows into the boundary of the shielding envelope. This increases resistance of the shield boundary to dispersal for a given volume flow of shielding gas and hence better protects the welding site from oxidation.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a perspective view of a preferred welding tip showing, in particular, an exemplary nozzle constructed and assembled on the head of a welding torch of conventional design in direct replacement for a standard nozzle.

FIG. 2 is an elevational view of the assembly of FIG. 1.

FIG. 3 is a sectional view of the assembly of FIG. 1.

FIG. 4 is a sectional view of the exemplary nozzle of FIG. 1.

FIG. 5 is an elevational view of the exemplary nozzle of FIG. 1.

FIGS. 6-9 are sectional views each of a respective variant of the nozzle.

FIG. 10 shows, in diagrammatic view, the operation of a nozzle constructed.

### DETAILED DESCRIPTION

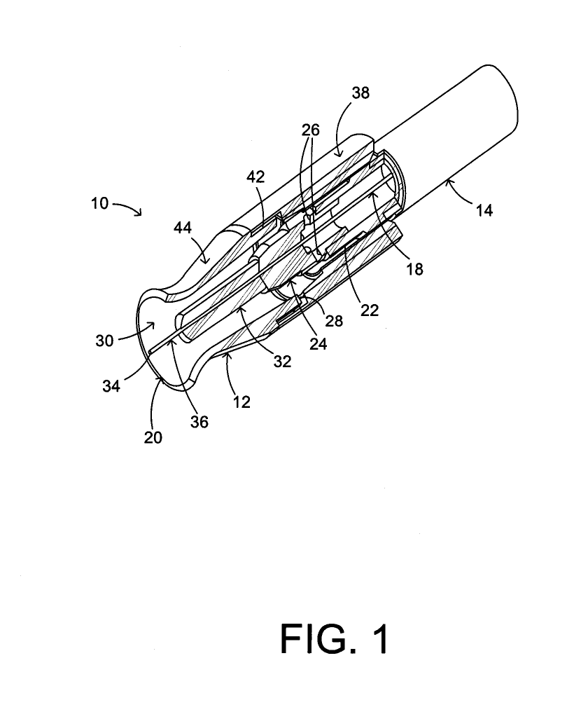

FIG. 1 is a perspective view of a welding tip 10 (the distal end portion of the welding torch) constructed in accordance with at least an embodiment. The welding tip uses a nozzle 12 of exemplary configuration which, in particular, is designed to facilitate efficient welding operations with a reduced rate of spatter buildup and a significantly reduced rate of gas consumption while maintaining weld quality. These advantages and related features of the nozzle are further described below. However, to place this description in context, it will first be described how the exemplary nozzle is configured for convenient use with a standard welding torch and, indeed, can be substituted as a direct replacement for nozzles of consumable type that are presently available commercially.

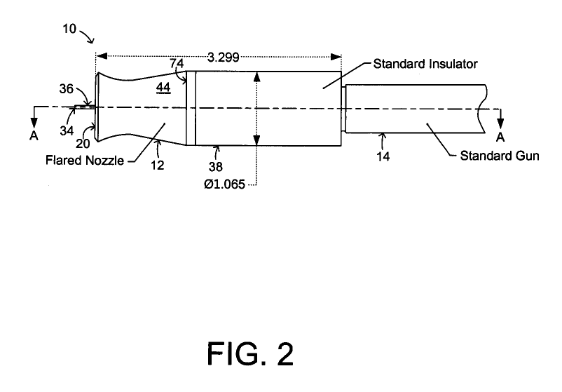

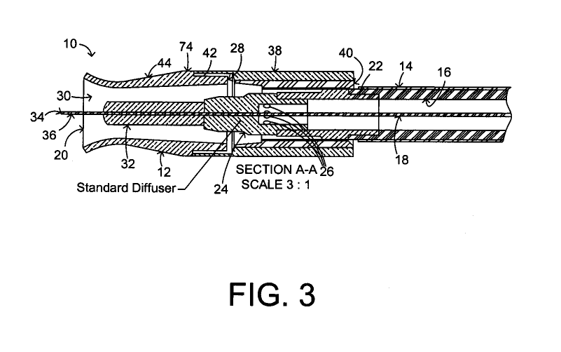

Referring also to FIGS. 2-3, which show the welding tip 10 in elevational and sectional view respectively, the head of a standard welding torch conventionally includes a conductor tube 14 which, for example, may extend from a trigger-operated welding gun and be goose-necked or flexible in shape (only the end portion of the conductor tube is shown). The conductor tube is hollow and lined with an insulative layer 16 to shield a “hot” wire 18 that is normally spool-fed or driven through the tube and out the open mouth 20 of the nozzle. A conduit liner, not shown, typically surrounds and helps prevent kinking in the driven wire. The hollow conductor tube also feeds an inert (or semi-inert) shielding gas to the welding tip, which passes through neckpiece 22 of the tube into a gas diffuser 24.

A circumferential series or ring of regularly spaced small openings 26 are formed in the diffuser 24 through which the shielding gas may enter the rear end 28 of the nozzle 12 for passage through a bore 30 of the hollow nozzle and discharge out the nozzle's open mouth 20. In accordance with conventional practice, the discharged gas provides a curtain or envelope that protects the weld site against atmospheric elements, including oxygen and nitrogen, that may damage weld quality. A contact tip 32 seats and directs the wire 18 centrally through the nozzle bore to maintain the forward tip 34 of the exposed portion 36 of the wire over the welding site. The electric arc established between the “hot” wire (electrode) and workpiece continuously melts the driven wire tip (at temperatures approaching 6500 degrees Fahrenheit) and the base metal to produce a molten pool that cools to form a solid joint of fused metal. A separate insulator 38 includes an insulative sleeve or lining 40 that electrically isolates the nozzle 12 from the hot wire 18. Alternatively, the gas diffuser may provide or be integrated with the insulator, be part of the tip holder, or be a separate part, as shown.

The rear portion 42 of the outer surface 44 of the exemplary nozzle 12 may be externally threaded to mate with internal threads within the insulator 38, or suitably dimensioned for pressure fit within a smooth bore of the insulator, or may be permanently joined with the insulator to form one integrated part. The particular connection method selected will depend on the specific commercial product for which the nozzle is designed as a replacement. For example, for interchangeability with a standard 24CT Tweco brand nozzle, the exemplary nozzle will include course threading on its rear outer surface to engage the inner threads of a 34CT Tweco insulator. Or, the construction of the exemplary nozzle may be integrated with the insulator in similar manner to a 24AT Tweco combined nozzle/insulator. The point here is that the exemplary nozzle 12 is readily adapted for interchangeability with standard parts.

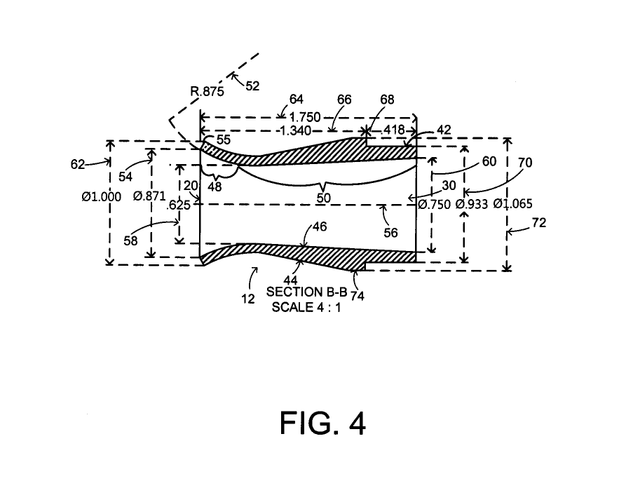

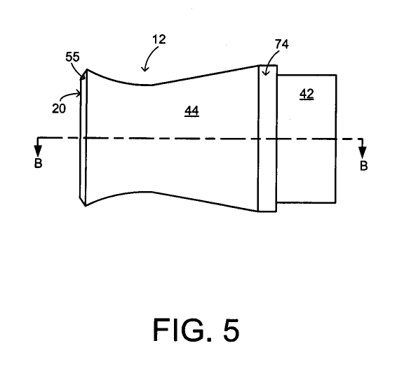

FIGS. 4 and 5 show, in sectional and elevational view respectively, specific details of the exemplary nozzle 12 that contribute to the nozzle's enhanced performance. To provide sufficient heat resistance and strength, the nozzle is desirably formed from suitable metallic material, such as tellurium copper alloy. Among its basic features, the nozzle has an inner wall 46 defining the bore 30 of the hollow nozzle. The bore includes a forward portion 48 that opens outwardly to terminate in the nozzle's open mouth 20 such that the forward portion has a generally flared shape. The bore further includes an inner portion 50 adjoining the forward portion. Preferably the inner wall is substantially smooth where the inner portion joins with the forward portion so that there are no jags or sharp edges at the transition. This minimizes eddy formation or other turbulence in the gas flowing across the transition. To similar end, preferably the inner wall is substantially smooth along both the forward portion and inner portion. Indeed, in the exemplary nozzle 12 depicted, the inner wall is not only smooth or free of jags, but preferably is highly polished, even to the extent of having a shiny finish. This further minimizes the occurrence of flow disturbances that could propagate to, and ruin the integrity of, the shielding envelope.

It will be apparent that the outwardly opening or generally flared shape of the forward portion 48 results in a larger shielding curtain. But this feature alone has been found, in practice, to offer inadequate protection; for example, it has been found that entrainment of oxygen within the flared envelope will likely occur causing porosity in the weld joint and, furthermore, excessive spatter buildup typically occurs. As will now be discussed, further features of the exemplary nozzle counteract these difficulties by ensuring that, for a given volume of gas flowing through the nozzle, a higher density is concentrated along the flared boundaries of the shielding curtain and also in the region immediately surrounding electrode tip. Such features enable the consumption rate of gas supplied to the nozzle to be significantly reduced so as to realize significant cost savings while, simultaneously, ensuring suitable conditions exist for high-quality welding.

Referring to FIG. 4, preferably the inner wall 46 of the nozzle is not only smooth but also gradually curves where the inner portion 50 of the bore joins the forward portion 48. In addition, the inner portion is configured to restrict any expansion of gas traveling along the inner portion adjacent to the forward portion. This means that surface gas flowing along the inner portion will at least maintain its pressure on the inner wall adjacent the transition and will tend to closely follow the gradual curve where the inner portion joins the forward portion rather than veer away from the curving wall. Indeed, it is preferable, as depicted, that the inner portion increasingly narrow or forwardly angle inwardly in approaching the forward portion, for this increases the pressure of surface gas on the inner wall and causes the gas to more closely adhere to or “hug” the inner wall. The inner portion preferably tapers inwardly for a sufficient length to ensure adequate buildup of surface gas pressure.

In addition, the forward portion 48 of the bore preferably opens outwardly in a gradual curve such that the generally flared shape of the forward portion is of gradually curving contour. For the exemplary nozzle 12 depicted in FIG. 4, the forward portion follows a predetermined radius of curvature, indicated by item 52, which is 875 inches (⅞ of an inch), that is approximately equal to the diameter 54 of the nozzle's open mouth 20, which is 0.871 inches. More generally, the contour should gradually bend enough to provide sufficient flaring of the shielding envelope yet not bend so steeply as to cause the shielding gas to veer off from the flare.

The narrowing taper of the inner portion 50 in approaching the forward portion 48, the gradual curving of the inner wall 46 where the forward portion joins the inner portion, and the gradual curving of the forward portion as it outwardly expands all work mutually together to cause the surface gas flow adjacent the flared wall to adhere to or “hug” the wall more closely so that a larger concentration of the shielding gas is discharged into the boundaries of the shielding envelope. This effectively reinforces the boundaries and prevents air penetration into the envelope for a greater time interval at a given gas dispersal rate. Putting it another way, a larger reserve of the shielding gas along the boundary provides extra protection against thinning and dispersal so that some dispersal may occur while still affording reliable protection around the weld. This substantially reduces weld quality problems caused by oxidation of the weld. Desirably, the forward portion and adjacent inner portion are of circular cross-section to ensure even pressure and flow of the surface gas along the forward portion and so that the reserve of gas concentrated along the shield boundaries is the same in all radial directions.

Another effect of the narrowing taper of the inner portion 50 adjacent the forward portion 48, the gradual curving at the transition, and the gradual outward curving of the forward portion, is that the evenly flowing gas hugs the flared wall to create an effective gas shield that closely follows the flared shape. This results in a relatively large “sweet spot” for positioning the forward tip 34 (FIG. 3) of the wire 18. In particular, during manual welding, there is less need for maintaining a constant forward tip-to-workpiece distance so that, as a result, significantly less operator care and skill is needed in manipulating the welding torch.

Furthermore, whether manual or automated welding is used, the larger “sweet spot” allows greater versatility in choosing the welding mode and setup. Both short arc (e.g., short-circuit) or long arc (spray or pulsed) modes may be used, and the higher concentration of gas at the envelope boundaries effectively protects the weld regardless of the geometry of the welding interface, that is, regardless of whether it is flat, grooved, straight joint, fillet joint, oriented downward, upward, sideways, and so forth. Moreover, in heavy production environments, the larger lateral (X/Y-axis) and height (Z-axis) tolerance in the position of the forward tip 34 relative to the weld site accommodates faster tip travel and weld deposition.

One the most significant effects of the narrowing taper of the inner portion 50 in approaching the forward portion 48, the gradual curving of the inner wall 46 where the forward portion joins the inner portion, and the gradual curving of the forward portion as it outwardly expands is that, in cooperation with certain arc-stabilizing elements further described below, these features work together to permit shielding effectiveness to be maintained despite a reduced rate of discharge of gas from the nozzle and slower replenishment of the gas shield. Not only does this reduce the likelihood of air entrainment and penetration of the shield due to velocity shear, the rate of gas supply to the nozzle may be substantially reduced. For example, whereas before a flow rate was needed of 45-50 CFH (cubic feet an hour) for spray arc welding and 30-35 CFH for short arc welding, the exemplary nozzle 12 tolerates a gas flow rate of 24-25 CFH for spray arc and 10-14 CFH for short arc. In other words, the present nozzle achieves substantial savings in the consumption rate of shielding gas on the order of 50%.

Referring to FIGS. 4 and 5 together, immediately adjacent the open mouth 20 of the nozzle, the nozzle has a chamfered edge 55 between its inner wall 46 and outer surface 44. The increased angle of the edge adjoining the inner wall traps a small component of the flaring gas just behind the open mouth, displaces the air immediately surrounding the mouth, and reduces the likelihood that outside air will be sucked into the mouth and entrained in the shielding gas.

As indicated in FIG. 4, preferably the inner portion 50 of the nozzle bore 30 is substantially smooth, straight, and of sufficient length to ensure adequate dampening of flow disturbances in the gas from where the gas is ejected by the gas diffuser openings 26 into the bore to where the gas enters the forward portion 48. As described above, some of the gas is desirably diverted by the forward portion for discharge into the boundaries of the flared shielding envelope. Further from the inner wall, however, the inner core of gas will continue to follow the straight contour of the inner portion in a regular and laminar flow. Provided also the cross-section of the bore is circular, the inner core of gas will be discharged so that it is concentrated uniformly in all radial directions about the exposed portion 36 (FIG. 3) of the centrally mounted electrode wire 18.

As described above, preferably the inner portion 50 of the nozzle's inner wall 46 also tapers inwardly. To facilitate laminar flow of the inner gas core, the inner portion desirably maintains a straight contour, that is, it tapers inwardly at a constant or predetermined angle relative to the center axis 56 of the circular bore. For the exemplary nozzle 12 depicted, this predetermined angle is within the range of 3 to 7 degrees or, more specifically, about 5 degrees. Another measure of the steepness of the predetermined angle is provided by the inner portion's minimum diameter 58 of 0.625 inches and maximum diameter 60 of 0.750 inches which occurs over a horizontal run of about 1.34 inches. For comparison, again the inner diameter 54 of the open mouth 20 in the illustrated embodiment is 0.625 inches.

The inward tapering of the inner portion 50 not only affects the surface gas flow (to cause that flow to adhere more closely to the flared portion as discussed above) but also affects the inner core of gas flow. Provided the wall 46 forwardly angles inwardly for a sufficient length at a suitable angle (e.g., not too steep as to allow flow disturbances), the inner gas core will be discharged so as to concentrate in the region immediately surrounding the centered electrode. This concentration makes it more likely that the arc formed by the ionized gas will be focused at the forward electrode tip 34 (FIG. 3), and the arc pathway is less likely to sputter, jump, or deviate sideways so as to blowout or propel melted particles from the electrode onto the inner wall.

This approach toward directing gas flows contrasts with previous attempts to control the arc energy by focusing the entire flow output of the nozzle. In the exemplary nozzle 12, the described forward portion 48 and inner portion 50 of the nozzle establish divergent flows of concentrated gas (surface and inner core) and a reduced proportion of the gas is diverted to the zone lying between the amply protected boundary region of the shielding envelope and the region immediately surrounding the electrode tip. As noted above, this results in significant cost savings on gas consumption.

A stabilized arc is particularly advantageous in “spray welding” in which a higher current and temperature is established in the arc (e.g., by increasing the voltage). This causes the electrode metal to melt and transfer rapidly along the arc from electrode to workpiece so that, with a stable arc, the melted particles are reliably and efficiently conveyed along the arc pathway.

Argon, when used as the shielding gas, has high ionization potential and provides a stable arc with excellent current path and high current density. Although the tendency in the past has been to limit the use of Argon gas due to its relatively high cost, the low gas consumption rate of the exemplary nozzle 12 makes Argon use acceptable for a much wider range of applications. Using pure Argon or, depending on weld materials, using Argon blended with a fractional component of one or more other gases, such as Helium or CO2, current and temperature may be increased for faster melting, higher metal transfer rate, better fusion, and deeper joint penetration. A higher metal transfer rate, in turn, supports efficient production in automated settings. Alternatively, for thinner weld materials, a pulsed spray may be used with lower heat, slower metal transfer, and a smaller weld pool.

In combination, the foregoing features of the exemplary nozzle 12 have a multiplier effect on reducing the rate of spatter buildup inside the nozzle. In particular, as described above, the narrowing taper of the inner portion 50 in approaching the forward portion 48, the gradual curving of the inner wall 46 where the forward portion joins the inner portion, and the gradual curving of the forward portion as it outwardly expands enable the gas flow to more closely adhere to the nozzle wall and flare more evenly when exiting so that the flared shape of the gas envelope is reliably consistent. This permits greater flexibility in tip positioning, allows back off of the tip and nozzle from the weld pool, and reduces spatter buildup inside the nozzle due to molten particles splashing back from the workpiece. Moreover, the higher concentration of gas flowing closely along the inner wall is better able to expel strayed particles before they can adhere to the wall. Simultaneously, the straight profile and inward tapering of the inner portion along a sufficient length ensures laminar flow of the inner core of gas inside the nozzle and inwardly concentrated discharge of the gas core, thus resulting in an increasingly concentrated ionized gas distribution immediate to the exposed electrode and enhanced arc stability. This, in turn, limits spatter buildup due to arc shifting or blow. In short, the identified features have a cumulative effect opposing more than one cause of spatter buildup.

Reducing the rate of spatter buildup within the nozzle desirably decreases the frequency of nozzle replacement and avoids work stoppages in high production environments. Also reducing spatter buildup rate further improves the weld quality, since spatter buildup is a significant contributor to gas flow disturbance and loss of integrity of the gas envelope.

In FIG. 4, selected dimensions of the exemplary nozzle 12 are clearly indicated. Collecting these measurements together in one place for convenience and completeness, the nominal dimensions in inches are as follows: the forward diameter 62 of the outer surface 44 of the nozzle is 1.000; the inner diameter 54 of the open mouth is 0.871; the minimum diameter 58 of the inner portion 50 is 0.625; the maximum diameter 60 of the inner portion is 0.750; the radius of curvature 52 of the forward portion 48 is 0.875; the total length 64 of the nozzle is 1.750; the forward length 66 is 1.340; the rearward length 68 of the nozzle's rear portion 42 is 0.410; the rear diameter 70 of the rear portion (without threading) is 0.933; and the maximum diameter 72 of the outer surface is 1.065. To obtain other nozzle sizes for interchangeability with standard parts, these dimensions may be proportionately scaled or adjusted correspondingly.

As depicted in FIG. 4, the exemplary nozzle 12 has a material thickness between the outer surface 44 and inner wall 46 that increases going from the open mouth 20 toward the rear portion 42. This wicks energy away from the thinner forward portion of the nozzle to the thicker portion so that the thinner portion doesn't deform under high heat. This also reinforces the thicker portion for safe handling through heavy welding gloves and any threading. Referring also to FIG. 5, a strip 74 along the portion of maximum nozzle thickness may be inscribed with a knurled pattern to facilitate secure gripping through heavy gloves and for ease in rotating the nozzle during installation and removal of the nozzle on the welding torch tube 14 or insulator 38.

The exemplary nozzle 12 may be conveniently manufactured in an automated production process by machining and polishing performed under computer numerical control (CNC). To start out, a rod or tube of suitable metal stock, such as tellurium copper alloy, is provided having an original thickness that matches the maximum diameter 72 (FIG. 4) which the nozzle will have when finished. The rod is introduced into the CNC lathe from the chuck end and is automatically extended and clamped to the appropriate length. A machining (carbide) metal cutting tool and viscous cooling fluid are then used for cutting and removing the appropriate amount of material from the outer surface 44 of the spinning blank so as to shape and polish the outer surface. The tool is then automatically changed by the machine to a boring tool (a carbide metal cutting tool slightly smaller than the inside diameter of the tube). Using the boring tool and viscous cooling fluid, the bulk of inner metal of the spinning blank is removed, the inside flare and taper are shaped, and the inner bore is polished. The cutting tool may then be replaced by a knurling tool to inscribe a knurled pattern on the outer surface along the nozzle's maximum thickness. The tool may then be changed again to cut the threads for a 2-piece nozzle (where the nozzle 12 and insulator 38 are separate pieces as shown in FIGS. 1-3). Finally, a parting tool is used to cut and separate the machined and finished nozzle from the tube, whereupon the CNC machine automatically ejects and clamps a suitable length for the next blank, and the process is repeated for manufacturing as much product as needed.

The inner bore of the nozzle can be polished manually or by an automated process using various techniques or mechanisms. Polishing of the inner bore desirably involves a multi-stage process, starting with a relatively rough abrasive in the first stage and utilizing a relatively finer abrasive in each subsequent stage. The rough abrasives remove surface defects like pits, nicks, lines and scratches. The finer abrasives leave very thin lines that are not visible to the naked eye. Lubricants, such as wax or kerosene may be used as lubricating and cooling media, depending on the polishing materials used. Buffing typically is the last stage of the polishing process and may be performed manually using a stationary polisher or die grinder, or via an automated process.

Two types of buffing motions can be employed: cut motion (cut buffing) or color motion (color buffing). Cut motion involves moving the workpiece against the rotation of the buffing wheel, using medium to hard pressure, and is intended to provide a uniform, smooth, semi-bright surface finish. Color motion involves moving the workpiece with the rotation of the buffing wheel, using medium to light pressure, and is intended to provide a clean, bright, shiny finish. In particular embodiments, the inner bore of the nozzle is polished to a grade 10 finish characterized by the surface structure being bonded and fused together at the subatomic level.

In particular embodiments, the inner bore is polished using a high-speed grinder equipped with various grades of sandpaper. The final polishing step of the inner bore desirably is performed using sandpaper or other abrasive material having a grade of at least 120-grit or higher. In one specific implementation, the inner bore is first polished using 120-grit sandpaper, then using 140-grit sandpaper, then using 160-grit sandpaper, then using 400-grit sandpaper, then using 600-grit sandpaper and finally the inner bore is buffed to a mirror finish using an airflow mop having a 15-micron buffing pad.

As indicated, the exemplary nozzle may be resized, as desired, for interchangeability with commercially available parts. Referring to FIG. 4, typical ranges include 0.5 to 1.5 inches for the forward diameter 62; 0.125 to 1.0 inch for the inner diameter 54; one-eighth inch to 1.5 inches for the radius of curvature 52; and 1.5 to 5.0 inches for the total length 64. Another alternative that may be implemented during the manufacturing process is to add nickel plating.

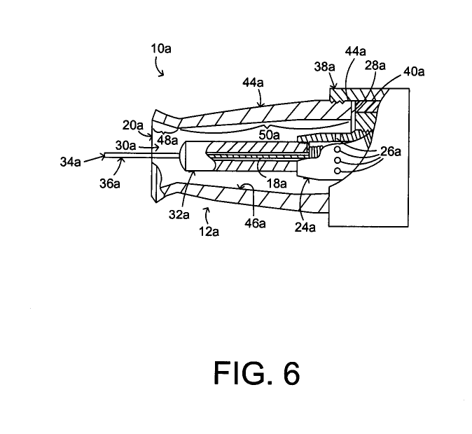

An exemplary embodiment of the welding tip 10 and nozzle 12 have now been described. However, other variants of the tip and nozzle are possible without departing from at least the broadest principles herein. To give a sense of the range of alternatives possible, several other constructions are depicted in FIGS. 6 to 10. For convenient reference, elements in these alternative designs equivalent to those of the exemplary embodiment are correspondingly numbered with letters added for demarcation. It will be recognized that the many advantages provided by the exemplary embodiment will be provided to a lesser degree by each of these designs in proportion to the extent that each design departs from the exemplary embodiment and fails to incorporate the full combination of operative features described above for the exemplary embodiment.

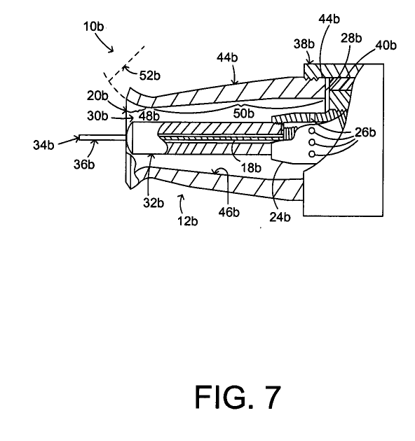

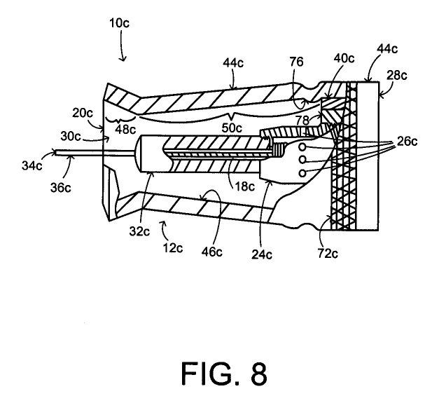

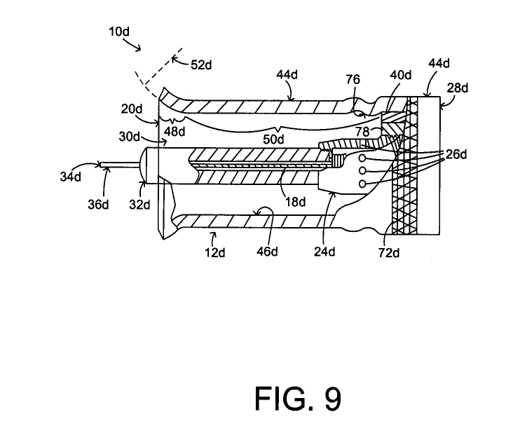

In FIG. 6, the nozzle 12a has an inner portion 50a that is smooth, highly polished, and inwardly tapering at a constant angle. The forward portion 48a is generally flared, and the transition between the inner and forward portions is smooth but noncurving. In FIG. 7, the nozzle 12b has a forward portion 48b opening outwardly in a generally flared and gradually curving profile with a smooth, straight, and circular inner portion 50b. In FIG. 8, the nozzle is similar to FIG. 6, but is a one-piece design integrated with the insulator component. The inner wall includes a crimp 76 that seats an insulative sleeve, made of G-7 silicon material, for electrical isolation from the diffuser, and the nozzle is further assembled with neckpiece or insert 78 made from solid brass to allow the machining of multiple internal threads to match varying diffusers 24c. The knurled pattern along the strip 72c of thickest nozzle diameter is also shown. FIG. 9 shows a nozzle 12d similar to that of FIG. 8 but the inner portion 50d is smooth, straight, and nontapered and the forward portion 48d is gradually curving.

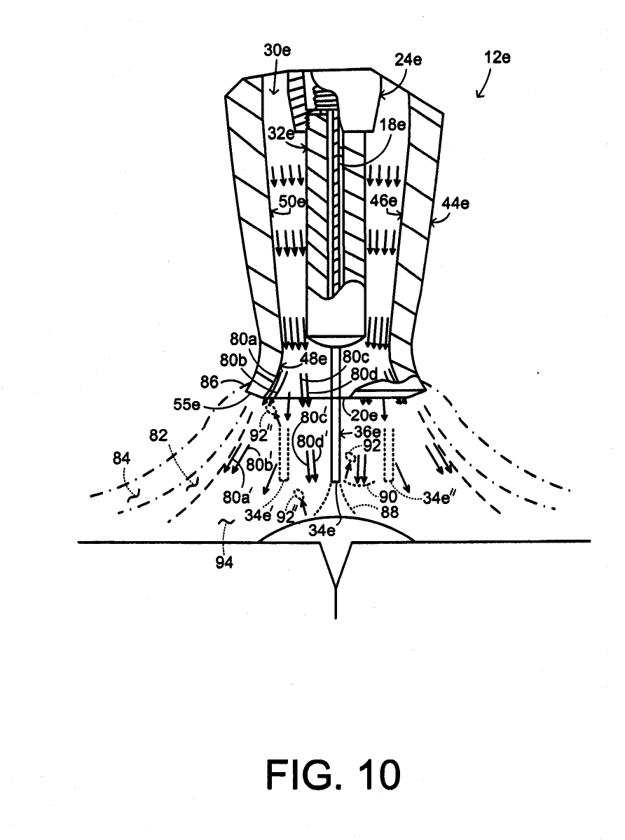

FIG. 10 represents, in diagrammatic form, the general operation of a nozzle 12e constructed generally in accordance with the preferred design. In particular, the nozzle includes a smooth, highly polished bore 30e of circular cross-section having a forward portion 48e of generally flared, gradually curving shape, joined with a narrowing inner portion 50e along a gradual curve. Hence, as described above, a surface flow of the shielding gas, indicated by elements 80a, b, closely adheres to the bore's inner wall and is evenly directed out the nozzle's mouth 20e, as indicated by 80a′, b′, to reliably provide a flared shielding envelope. The concentrated surface flow reinforces the envelope along its boundary region, indicated by item 82. This boundary region is of uniform integrity in all radial directions. The effective outermost region 84 of the shielding envelope extends at lower concentration somewhat beyond this reinforced region, as indicated, including a portion of gas 86, which is trapped behind the chamfered edge 55e of the open mouth and displaces the outside air from approaching the mouth.

The inner portion 50e of the bore tapers inwardly at a constant angle for a length sufficient to dampen flow disturbances. Hence an inner core of gas flow, indicated by elements 80c, d, is directed in laminar flow out the nozzle's mouth for concentration immediately about the exposed wire electrode 36. The inner core flow, preferably of high ionization potential, stabilizes the electric arc 88 at the electrode tip 34e. That is, the arc will resist following an erratic path 90 that takes it into a less concentrated ionization zone, which in turn reduces spatter buildup by preventing highly energized blowout of any spatter particle 92 from the tip. In the intermediate shielding zone 94, a relatively lower concentration of gas than usual is needed for maintaining weld quality between the reinforced boundary region 82 and the concentrated gas flow about the electrode, hence enabling significantly reduced gas consumption. The forward tip 34e may be flexibly positioned, including in the lateral direction, as indicated in outline by items 34e′, e″, thus enabling faster tip travel (e.g., into or out of the page) and weld deposition, and also in the Z-axis direction, thus enabling reduced care or skill in torch manipulation and greater versatility in weld technique, materials, and geometry. Also, the tip may be backed off further from the workpiece to reduce spatter buildup caused by splash back of any spatter particle 92″ from the workpiece. The concentration of surface gas flow along the inner wall, 80a, b, also tends to reduce spatter buildup by expelling any stray spatter particle 92″ approaching the nozzle's inner wall.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

We claim:

1. A welding tip comprising:
(a) a hollow nozzle having an inner wall forming a bore, the bore including a forward portion terminating in an open mouth and an inner portion joined to the forward portion;
(b) the forward portion having a generally flared shape;
(c) the inner wall being substantially smooth where the inner portion joins the forward portion; and
(d) the inner portion being configured to restrict any expansion of gas traveling along the inner portion adjacent to the forward portion.

2. The welding tip of claim 1 wherein the inner wall gradually curves where the inner portion joins the forward portion.

3. The welding tip of claim 1 wherein the flared shape is of gradually curving contour.

4. The welding tip of claim 1 wherein the inner portion is of substantially straight contour.

5. The welding tip of claim 1 wherein the inner wall is substantially smooth along the forward portion.

6. The welding tip of claim 1 wherein the inner wall is substantially smooth along the inner portion.

7. The welding tip of claim 1 wherein the inner wall is of machined and polished metal.

8. The welding tip of claim 1 wherein the inner wall has a shiny finish.

9. A welding tip comprising:
(a) a hollow nozzle having an inner wall forming a bore, the bore including a forward portion and an inner portion adjoining the forward portion;
(b) the forward portion opening outwardly to terminate in an open mouth; and
(c) the inner portion tapering inwardly in approaching the forward portion.

10. The welding tip of claim 9 wherein the bore has a center axis and the inner portion tapers inwardly at a predetermined angle relative to the center axis.

11. The welding tip of claim 9 wherein the forward portion curves gradually.

12. The welding tip of claim 11 wherein the inner portion and forward portion are smoothly joined.

13. The welding tip of claim 12 wherein the inner wall gradually curves to join the inner portion and the forward portion.

14. A welding tip comprising:
(a) a hollow nozzle having an inner wall forming a bore, the bore including a forward portion and an inner portion adjoining the forward portion;
(b) the forward portion opening outwardly and terminating in an open mouth; and
(c) the inner wall gradually curves to join the inner portion and the forward portion together.

15. The welding tip of claim 14 wherein the inner portion increasingly narrows in approaching the forward portion.

16. The welding tip of claim 14 wherein the forward portion opens outwardly in a gradual curve.

17. The welding tip of claim 16 wherein the forward portion is of circular cross-section.

18. The welding tip of claim 17 wherein the inner portion forwardly angles inwardly.

19. The welding tip of claim 18 wherein the inner portion has a substantially straight profile.

20. The welding tip of claim 19 wherein the inner portion is of circular cross-section.

21. A welding tip comprising:
(a) a hollow nozzle having an inner wall forming a bore, the bore including a forward portion and an inner portion adjoining the forward portion;
(b) the forward portion opening outwardly to terminate in an open mouth; and
(c) the inner portion free from including a sleeve therein in a region approaching the forward portion.

22. The welding tip of claim 21 wherein the bore is configured so that, in relation to a wire electrode mounted in centered position to the bore with an exposed portion extending perpendicular to the mouth, gas discharged from the mouth flows radially uniformly relative to the exposed portion.

23. The welding tip of claim 21 wherein the nozzle has an outer surface and the thickness between the inner wall and outer surface increases going from the forward portion to the inner portion.

24. The welding tip of claim 21 including a chamfered edge adjacent the open mouth.

25. The welding tip of claim 21 wherein the inner portion has a maximum diameter less than the maximum diameter of the open mouth.

26. The welding tip of claim 21 wherein the nozzle is integrably constructed with an insulator for electrically isolating the nozzle from a charged electrode mounted within the bore of the nozzle.

27. The welding tip of claim 21 wherein the inner portion tapers inwardly over a distance exceeding the length of the forward portion.

28. The welding tip of claim 27 wherein the inner portion tapers inwardly over a length exceeding three times the length of the forward portion.

29. The welding tip of claim 27 wherein the bore has a center axis and the inner portion tapers inwardly at a predetermined angle relative to the center axis, the predetermined angle being within the range of 3 to 7 degrees.

30. The welding tip of claim 29 wherein the predetermined angle is about 5 degrees.

31. The welding tip of claim 21 wherein the open mouth is of circular cross-section and the forward portion has a predetermined radius of curvature about equal to the diameter of the open mouth.

32. The welding tip of claim 21 wherein a shielding gas discharged from the bore of the nozzle has a high ionization potential.

33. The welding tip of claim 32 wherein the shielding gas is Argon or Argon blended with a fractional component composed of at least one other gas.
